(19) United States
(12) Patent Application Publication
(10) Pub. No.: US 2018/0011975 A1
(43) Pub. Date: Jan. 11, 2018

(54) HUMAN BODY CHARACTERISTIC DATA PROCESSING METHOD AND APPARATUS

(71) Applicant: ZTE CORPORATION, Shenzhen, Guangdong (CN)

(72) Inventors: Fan ZHANG, Guangdong (CN); Zhuo CHEN, Guangdong (CN)

(73) Assignee: ZTE Corporation, Shenzhen, Guangdong (CN)

(21) Appl. No.: 15/543,621

(22) PCT Filed: Jul. 2, 2015
(86) PCT No.: PCT/CN2015/083168

§ 371 Date: Jul. 14, 2017

(30) Foreign Application Priority Data
Jan. 20, 2015 (CN) 201510027929.8

(51) Int. Cl. G06F 19/00

(52) U.S. Cl. CPC G06F 19/324; G06F 19/3437

(57) ABSTRACT

The present disclosure relates to a method and device for processing human body characteristic data. The method includes: receiving a set of human body characteristic information transmitted by a terminal; and according to requirements of an application to be run, extracting, from the set of human body characteristic information, human body characteristic data corresponding to the application to be run, and performing data reconstruction process on the extracted human body characteristic data.

### CROSS-REFERENCE TO RELATED APPLICATIONS

This application is based upon and claims priority to Chinese Patent Application No. 201510027929.8, filed Jan. 20, 2015, the entire contents of which are incorporated herein by reference.

### TECHNICAL FIELD

The present disclosure relates to the communication field, and more particularly, to a method and device for processing human body characteristic data.

### BACKGROUND

Virtual human technology, i.e., digitalization of human, is one of the sought-after frontier applications of information technology under the present background of big data. The virtual human technology is based on collection of large amount of human body characteristic data, it extracts key human characteristics through data processing and operation, and then through artificial intelligence, it uses equipment to achieve a digital human based on a calculation model. Actions, expressions, languages and other characteristics of the virtual human can be realized through display technologies, and the virtual human is fairly similar to the real humans from whom data is collected and can independently communicate with other real humans or virtual humans.

Handheld mobile terminals, represented by smartphones, are communication and entertainment devices that are almost indispensable to humans every day. These hand-held terminals are equipped with a variety of information acquisition devices therein, such as cameras, acceleration geomagnetic sensors, and microphones, and therefore are suitable for being used as tools for collecting large amount of human body characteristic data. in addition, it was difficult to process large amount of data by only relying on hardware configuration of the handheld terminals. With the rapid development of broadband mobile communications, mobile phones can realize transfer and real-time processing of big data by relying on wireless broadband networks and powerful cloud computing platforms. Therefore, there is provided an effective technical basis for using handheld terminals to cooperate with the cloud computing platforms to realize human body characteristic data collection and extraction.

However, related arts do not provide a technology for collecting human body characteristic information by a smart mobile terminal and processing human body characteristic data by a cloud computing platform which matches the smart mobile terminal.

This section provides background information related to the present disclosure which is not necessarily prior art.

### SUMMARY

Embodiments of the present disclosure provide a method and device for processing human body characteristic data, in order to at least solve the problem that related arts do not provide a technology for collecting human body characteristic information by a smart mobile terminal and processing human body characteristic data by a cloud computing platform which matches the smart mobile terminals.

According to an aspect of embodiments of the present disclosure, there is provided a method for processing human body characteristic data.

The method for processing human body characteristic data according to an embodiment of the present disclosure includes steps of:

receiving a set of human body characteristic information transmitted by a terminal; and

according to requirements of an application to be run, extracting, from the set of human body characteristic information, human body characteristic data corresponding to the application to be run, and performing data reconstruction process on the extracted human body characteristic data.

According to an exemplary embodiment, the step of extracting, from the set of human body characteristic information, human body characteristic data according to requirements of an application to be run includes:

according to the requirements of the application to be run, determining information about multiple categories which human body characteristic information to be used belongs to, wherein the human body characteristic information to be used includes the human body characteristic data; and

extracting the human body characteristic data from the set of human body characteristic information according to the determined information about the multiple categories.

According to an exemplary embodiment, the step of performing data reconstruction process on the extracted human body characteristic data includes:

classifying the human body characteristic data, and parsing the human body characteristic data of each category using a preset recognition algorithm;

analyzing validity of the parsed human body characteristic data according to the requirements of the application to be run; and

obtaining a correlation between the parsed human body characteristic data according to a preset correlation algorithm.

According to an exemplary embodiment, after the step of performing the data reconstruction process on the human body characteristic data, the method further includes:

determining whether a preset event occurs and progress of the preset event using the human body characteristic data after the data reconstruction process.

According to an exemplary embodiment, the set of human body characteristic information includes at least one of human body audio data, human body image data, and human body motion data.

According to another aspect of embodiments of the present disclosure, there is provided a device for processing human body characteristic data.

The device for processing human body characteristic data according to an embodiment of the present disclosure includes:

a receiving module configured to receive a set of human body characteristic information transmitted by a terminal; and

a process module configured to, according to requirements of an application to be run, extract, from the set of human body characteristic information, human body characteristic data corresponding to the application to be run, and perform data reconstruction process on the extracted human body characteristic data.

According to an exemplary embodiment, the process module includes:

a determination unit configured to, according to the requirements of the application to be run, determine information about multiple categories which human body characteristic information to be used belongs to, wherein the human body characteristic information to be used includes the human body characteristic data; and

an extraction unit configured to extract the human body characteristic data from the set of human body characteristic information according to the determined information about the multiple categories.

According to an exemplary embodiment, the process module includes:

a parsing unit configured to classify the human body characteristic data, and parse the human body characteristic data of each category using a preset recognition algorithm;

an analyzing unit configured to analyze validity of the parsed human body characteristic data according to the requirements of the application to be run; and

an obtaining unit configured to obtain a correlation between the parsed human body characteristic data according to a preset correlation algorithm.

According to an exemplary embodiment, the device further includes:

a determination module configured to determine whether a preset event occurs and progress of the preset event using the human body characteristic data after the data reconstruction process.

According to un exemplary embodiment, the set of human body characteristic information includes at least one of human body audio data, human body image data, and human body motion data.

In the embodiments of the present disclosure, a set of human body characteristic information transmitted by a terminal is received; and according to requirements of an application to be run, human body characteristic data corresponding to the application to be run is extracted from the set of human body characteristic information, and data reconstruction process is performed on the extracted human body characteristic data. Thus, the technical solutions provided by embodiments of the present disclosure can solve the problem that related arts do not provide a technology for collecting human body characteristic information by a smart mobile terminal and processing human body characteristic data by a cloud computing platform which matches the smart mobile terminal. Consequently, the technical solutions provided by embodiments of the present disclosure can effectively establish an information body of a virtual human at a cloud end, and provide reliable technical support for construction applications of the virtual human.

This section provides a summary of various implementations or examples of the technology described in the disclosure, and is not a comprehensive disclosure of the full scope or all features of the disclosed technology.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart showing a method for processing human body characteristic data according to an embodiment of the present disclosure.

FIG. 2 is a block diagram showing a structure of a device for processing human body characteristic data according to an embodiment of the present disclosure.

FIG. 3 is a block diagram showing a structure of a device for processing human body characteristic data according to an embodiment of the present disclosure.

FIG. 4 is a block diagram showing a structure of a system for processing human body characteristic data according to an embodiment of the present disclosure.

FIG. 5 is a schematic diagram showing a RAKE process structure according to an embodiment of the present disclosure.

FIG. 6 is a schematic diagram showing a data reconstruction procedure according to an embodiment of the present disclosure.

FIG. 7 is a flowchart based on a data reconstruction procedure of FIG. 4 according to an embodiment of the present disclosure.

### DETAILED DESCRIPTION

The present disclosure will be described in detail in the following embodiments with reference to the drawings. It should be noted that embodiments and features in embodiments can be combined with each other without conflict.

FIG. 1 is a flowchart showing a method for processing human body characteristic data according to an embodiment of the present disclosure. As shown in FIG. 1, the method may include the following process steps.

In step S102, a set of human body characteristic information transmitted by a terminal is received.

In S104, according to requirements of an application to be run (for example, a particular application program is run to predict the probability that a user may have a cold in the future), human body characteristic data corresponding to the application to be run is extracted from the set of human body characteristic information, and data reconstruction process is performed on the extracted human body characteristic data.

Related arts do not provide a technology for collecting human body characteristic information by a smart mobile terminal and processing human body characteristic data by a cloud computing platform which matches the smart mobile terminals. In the method as shown in FIG. 1, after collection of human body characteristic information by a smart mobile terminal, a cloud computing platform extracts human body characteristic data and performs a data reconstruction process. Thus, the method described with reference to FIG. 1 can solve the problem that related arts do not provide a technology for collecting human body characteristic information by a smart mobile terminal and processing human body characteristic data by a cloud computing platform which matches the smart mobile terminal. Consequently, the method can effectively establish an information body of a virtual human at a cloud end, and provide reliable technical support for construction applications of the virtual human.

According to an exemplary embodiment, the set of human body characteristic information may include but not limited to at least one of:

(1) human body audio data, for example, data of voice made by a user using a microphone built in a mobile terminal;

(2) human body image data, for example, data of facial expression of a user; and

(3) human body motion data, for example, activity data of a user within a preset time period.

According to an exemplary embodiment, in 5104, extracting, from the set of human body characteristic information, human body characteristic data according to requirements of an application to be run may include the following operations.

In step S1, according to the requirements of the application to be run, information about multiple categories which human body characteristic information to be used belongs to is determined. The human body characteristic information to be used includes the human body characteristic data.

In step S2, the human body characteristic data is extracted from the set of human body characteristic information according to the determined information about the multiple categories.

According to an exemplary embodiment, continuous changes of voice, motion and facial image information of human body over time can be collected by sensor devices built in smart handheld mobile terminal (for example, a microphone (MIC), a camera, an acceleration geomagnetic sensor, or a gyroscope in a smart phone, a PAD, or an electronic book, or a body temperature sensor or a heart rate sensor in a smart watch), and continuously transmitted to a background cloud end. The data volume is huge and data contents are very rich. Thus, all data which can be collected using the functions which the terminal have can be defined as a set of human body characteristic information. And, which data should be used. depends on actual requirements of the application to be run. For example, an application is responsible for predicting the probability that a user will catch a cold in a future period of time. The application needs to obtain the number of times the user sneezes, the number of coughs, the temperature, the pulse, and sleepy expression of the user for several successive days. The number of times the user sneezes, the number of coughs, the temperature, the pulse, and sleepy expression of the user and the like which need to be obtained for several successive days can be defined as the human body characteristic information to be used. The data about the sneezes and coughs belongs to audio data, the data about the temperature and heart rate belongs to skin-sensing data, and the data about the sleepy expression belongs to human facial image data, and thus the audio data, the image data and the like can be defined as information about multiple categories which human body characteristic information to be used belongs to.

It should be noted that, different terminals may have different functions, and if it is assumed that three categories of data: audio data, sensing data and image data (i.e., the human body characteristic information to be used), need to be obtained according to requirements of the application to be run, due to function differences of individual terminals, the data (i.e., the set of human body characteristic information) which a terminal can provide based on the functions of the terminal itself can only be limited to the audio data and the image data, or all three categories of data can be provided; or, a terminal can provide other data (for example, motion data) than the three categories of data. Thus, the intersection between the human body characteristic information to be used and the set of human body characteristic information should be selected as the human body characteristic data.

According to an exemplary embodiment, in step S104, performing data reconstruction process on the extracted human body characteristic data may include the following steps.

In step S3, the human body characteristic data is classified, and the human body characteristic data of each category is parsed using a preset recognition algorithm, for example, the maximum similarity algorithm.

For example, audio data such as user voice is collected by a terminal. Such audio data may include cries, laughters, coughs of the user. Thus, it is needed to parse the cries, laughters, coughs using corresponding feature recognition algorithms to distinguish the cries, laughters, coughs.

In step S4, validity of the parsed human body characteristic data is analyzed according to the requirements of the application to be run.

For example, during the collection of the user's sounds by the terminal, the terminal may collect and report sounds of other people surrounding the user as well. Thus, it is needed to distinguish the sounds of the user of the handheld terminal from the sounds of other people by validity analysis; only the sounds of the user may be saved, and the sounds of other people may be filtered.

In step S5, a correlation between the parsed human body characteristic data may be obtained according to a preset correlation algorithm, for example, the least mean squares algorithm for pattern recognition.

For example, whether there is an obvious fluctuation in the sound made by the user of the handheld terminal in the current call as compared with the sound made by the user in the last call can be determined, thereby determining whether the user has physical abnormalities. For example, if the user has caught a cold, his or her may be husky.

According to an exemplary embodiment, after selection of valid data, a data reconstruction process may be performed on the selected valid data. The purpose of the reconstruction is to classify the valid data according to the requirements of subsequent operations and apply tags to the valid data, which can thereby effectively reduce the operation complexity of the determination module, and increase determination efficiency and accuracy.

The data reconstruction procedure may include characteristic marking, validity marking, and correlation directionality and marking.

(1) The characteristic marking refers to identification of data types, i.e., voices, images and physical signs. Different characteristic data can be parsed using different pattern recognition algorithms. For example, audio data generated during successive calls of a user of a handheld terminal may be collected, and different categories of sounds such as laughters, cries and coughs can be distinguished.

(2) The validity marking refers to that after the characteristic data is analyzed, whether the current data is valid for the application can be marked. Validity marking group can be established for frequently used applications. For example, sounds made by talking people surrounding a user may be mixed in the collected audio data of the user, and thus the validity marking procedure is needed to filter the sounds made by the surrounding people while maintaining only the sounds made by the user.

(3) The correlation directionality marking is used to mark (or indicate) the direct correlation between the characteristic data according to calculation results generated from correlation calculation of different characteristic data. For example, by successive collection of the sounds made by a user in multiple calls, if it is found that the user is gradually husky, and more coughs occur, it can be determined that the user has caught a cold, and symptoms such as fever occur.

According to an exemplary embodiment, in step S104, after the data reconstruction is performed on the human body characteristic data, the following operations may be included:

Step S6: determining whether a preset event occurs and progress of the preset event using the human body characteristic data after the data reconstruction process.

In the exemplary embodiment, an event which may occur currently and the severity of the event can be determined based on the information after the data reconstruction process, and thereby corresponding early warnings and solutions can be provided. For example, an application program may be developed in advance to specifically determine whether a user has caught a cold or has had a fever. By performing the characteristic analysis, validity analysis and correlation analysis as described above, the application program may determine whether a user has caught a cold or has had a fever; if the user has caught a cold or has had a fever, the application program may remind the user to take actions, such as take medicine and see a doctor as soon as possible; if it is determined that the user tends to catch a cold or have a fever, the application program may advise the user to take medicine in time and take protection against the cold.

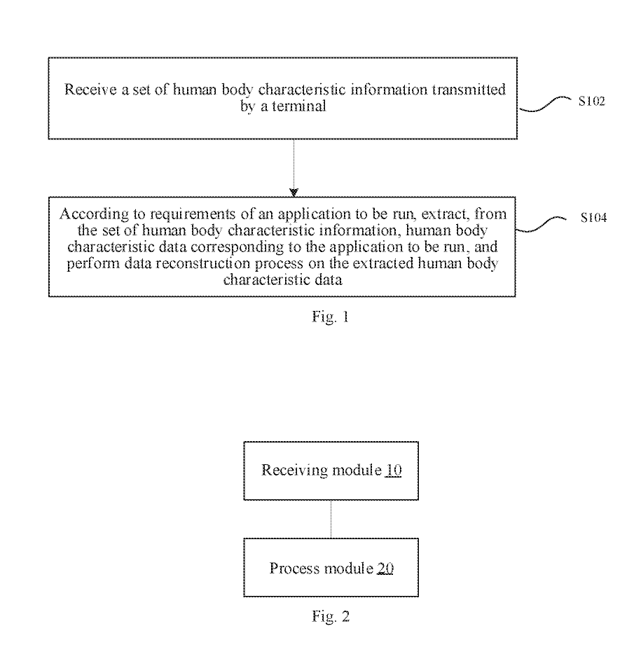

FIG. 2 is a block diagram showing a structure of a device for processing human body characteristic data according to an embodiment of the present disclosure. As shown in FIG. 2, the device for processing human body characteristic data may include a receiving module 10 and a process module 20. The receiving module 10 is configured to receive a set of human body characteristic information transmitted by a terminal. The process module 20 is configured to, according to requirements of an application to be run, extract, from the set of human body characteristic information, human body characteristic data corresponding to the application to be run, and perform data reconstruction process on the extracted human body characteristic data.

The device as shown in FIG. 2 can solve the problem that related arts do not provide a technology for collecting human body characteristic information by a smart mobile terminal and processing human body characteristic data by a cloud computing platform which matches the mobile terminal. Consequently, the device can effectively establish an information body of a virtual human at a cloud end, and provide reliable technical support for construction applications of the virtual human.

According to an exemplary embodiment, the set of human body characteristic information may include but not limited to at least one of:

(1) human body audio data, for example, data of voice made by a user using a microphone built in a mobile terminal;

(2) human body image data, for example, data of facial expression of a user; and

(3) human body motion data, for example, activity data of a user within a preset time period.

According to an exemplary embodiment, the process module 20 may include a determination unit (not shown) and an extraction unit (not shown). The determination unit is configured to, according to the requirements of the application to be run, determining information about multiple categories which human body characteristic information to be used belongs to, wherein the human body characteristic information to be used includes the human body characteristic data. The extraction unit is configured to extract the human body characteristic data from the set of human body characteristic information according to the determined information about the multiple categories.

According to an exemplary embodiment, the process module 20 may include a parsing unit (not shown), an analyzing unit (not shown) and an obtaining unit (not shown). The parsing unit is configured to classify the human body characteristic data, and parse the human body characteristic data of each category using a preset recognition algorithm. The analyzing unit is configured to analyze validity of the parsed human body characteristic data according to the requirements of the application to be run. The obtaining unit is configured to obtain a correlation between the parsed human body characteristic data according to a preset correlation algorithm.

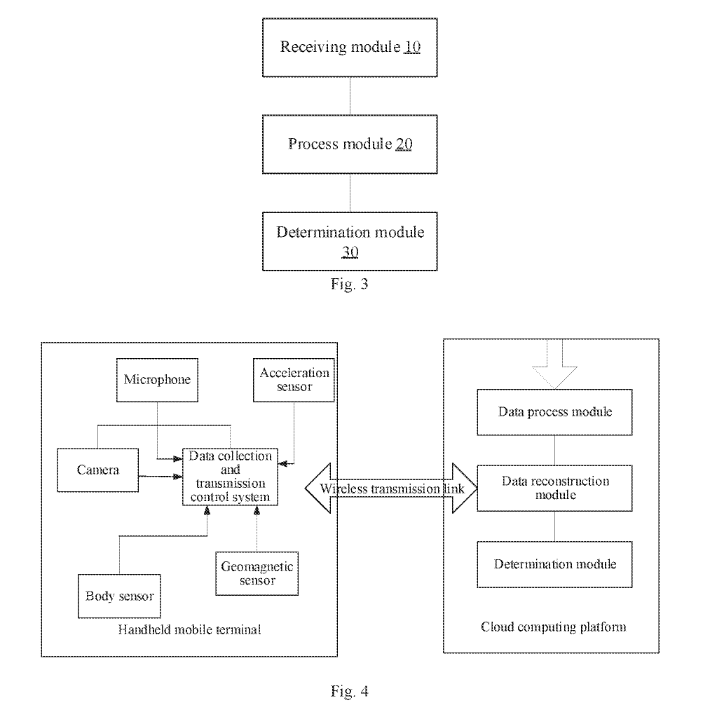

According to an exemplary embodiment, as shown in FIG. 3, the device may further include a determination module 30. The determination module 30 is configured to determine whether a preset event occurs and progress of the preset event using the human body characteristic data after the data reconstruction process.

FIG. 4 is a block diagram showing a structure of a system for processing human body characteristic data according to an embodiment of the present disclosure. As shown in FIG. 4, in the exemplary embodiment of the present disclosure, a handheld terminal may include the following accessories: a microphone, a camera, an acceleration sensor, a body sensor, and a geomagnetic sensor. These accessories are managed and controlled by a data collection and transmission control system. In order to effectively extract human body characteristic information, a data process module (which is an equivalent of the above determination unit and the extraction unit) is provided. The data process module is named as RAKE (which, as its name suggests, works like a rake, a garden tool consisting of a row of metal or wooden teeth attached to a long handle). By the RAKE, data for different applications can be extracted from a large amount of data, and the extracted data can be sent to a subsequent data reconstruction module which performs data reconstruction on the extracted data to build association between human body information. In addition, the data after reconstruction may be sent to the determination module which determines whether a preset event occurs and progress of the preset event using the human body characteristic data after the data reconstruction process.

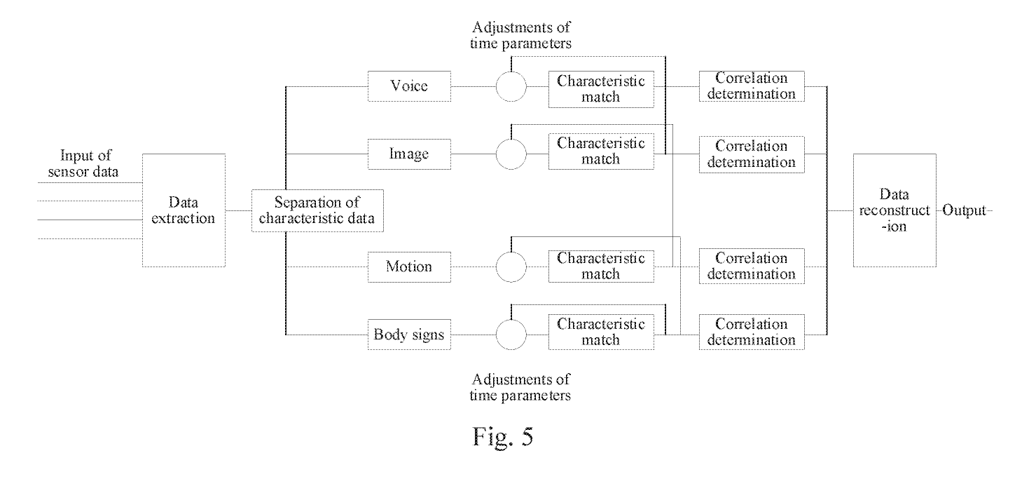

FIG. 5 is a schematic diagram showing a RAKE process structure according to an embodiment of the present disclosure. As shown in FIG. 5, the function of RAKE is to define the specification of the rake according different requirements of multiple applications to extract valid human body characteristic data to different extents. Extraction and classification operations can be effectively performed by the rake.

Each rake teeth may represent one human body characteristic category, and the bar between rake teeth represents the time interval for collecting the characteristic data. The thickness and length of each rake tooth represents the recognition depth of a human body characteristic. The distance between rake teeth is adjustable and represents temporal correlation degree between different human body characteristic data. The thickness of each rake tooth is adjustable and represents the depth of the algorithm for recognizing human body characteristics.

For example, an application is responsible for predicting the probability that a user will catch a cold in a future period of time. The application needs to obtain the number of times the user sneezes, the number of coughs, the temperature, the pulse, and sleepy expression of the user for several successive days. The data about the sneezes and coughs belongs to audio data, the data about the temperature and heart rate belongs to skin-sensing data, and the data about the sleepy expression belongs to human facial image data. These types of data can be the teeth of the RAKE. The temporal relationship between times for coughs and temperature changes and the times when the user shows the sleepy expression are the bars of the RAKE.

If the times for coughs and sneezes are highly consistent with the times for rises in body temperature, it can be determined that the probability for the user to catch a cold is very high; if the direct temporal correlation between the times for coughs and sneezes and the times for rises in body temperature is low, there is an intermediate probability for the user to catch a cold; if the correlation between the times for coughs and sneezes and the times for rises in body temperature approaches zero, there is little probability for the user to catch a cold. If a particular application is needed to analyze deep causes for the user's cold, more. complex recognition algorithms may be applied on the three teeth for the acoustic properties of coughs, temporal changes of body temperature and heart rate data. For example, whether audio features representing vibration of lung lobe exist in the audio data for coughs may be recognized so as to determine whether the coughs are caused by upper respiratory tract infection or by pulmonary infection. The change degree of the body temperature per unit time may be used to determine whether there is inflammation currently and the severity of the inflammation. By analysis of the heart rate data, whether there is abnormal electrocardiogram data such as premature pulse or fibrillation may be determined, so as to further determine whether there is inflammation of the heart muscle. In this way, the type of the cold which the user may currently catch and the severity of the cold may be provided. For example, the application may determine whether the user has caught upper respiratory tract infection, or pulmonary infection or myocarditis, and provide corresponding warnings and solutions accordingly.

After selection of valid data using RAKE, the data reconstruction module (corresponding to the above parsing unit, the analyzing unit and the obtaining unit) is used to perform the data reconstruction process. The purpose of the reconstruction is to classify the valid data according to the requirements of the determination module and apply tags to the valid data, which can thereby effectively reduce the operation complexity of the determination module, and increase determination efficiency and accuracy.

The data reconstruction module may be used for characteristic marking, validity marking, and correlation directionality and marking.

(1) The characteristic marking refers to identification of data types, i.e., voices, images and physical signs. Different characteristic data can be parsed using different pattern recognition algorithms. Standard algorithms in related arts can be used as the recognition algorithms, and detailed descriptions about the recognition algorithms are omitted here.

(2) The validity marking refers to that after the characteristic data is analyzed, whether the current data is valid for the application can be marked based on the correlation analysis results. Validity marking group can be established for frequently used applications.

(3) The correlation directionality marking is used to mark (or indicate) the direct correlation between the characteristic data according to calculation results generated from correlation calculation of different characteristic data. Standard algorithms in related arts can be used as the correlation algorithms, and detailed descriptions about the correlation algorithms are omitted here.

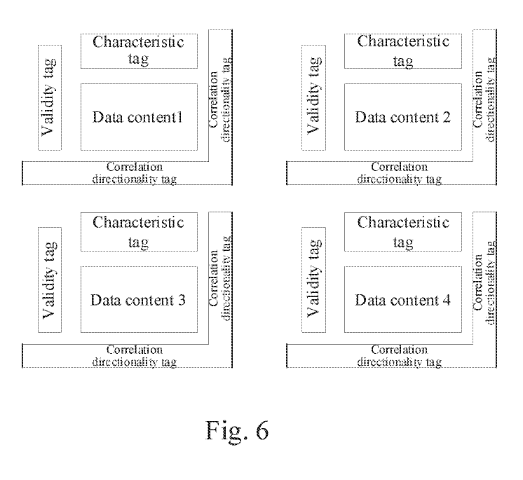

FIG. 6 is a schematic diagram showing a data reconstruction procedure according to an embodiment of the present disclosure. As shown in FIG. 6, by performing characteristic marking, validity marking and correlation directionality marking on the classified data contents, effective technical support for collecting human body characteristic data using a handheld terminal in corporation with a cloud computing platform can be provided. For example, audio data generated during successive calls of a user of a handheld terminal may be collected, different categories of sounds such as laughters, cries and coughs can be distinguished, and characteristic marker can be added for each sound category; sounds made by talking people surrounding the user may be mixed in the collected audio data of the user, and thus the validity marking procedure is needed to filter the sounds made by the surrounding people while maintaining only the sounds made by the user, and then a validity marker may be added; if it is found by successively collecting the sounds made by the user in multiple calls that the user is gradually husky and more coughs occur, it can be determined that the user has caught a cold, and symptoms such as fever occur; and, a correlation directionality marker may be added.

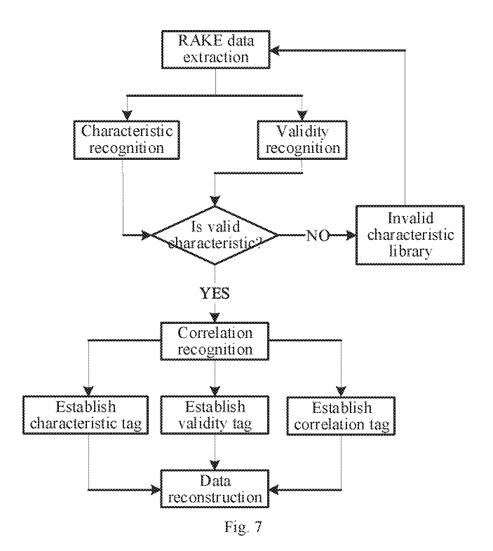

FIG. 7 is a flowchart based on the data reconstruction procedure of FIG. 4 according to an embodiment of the present disclosure. As shown in FIG. 7, the procedure may include the following process steps. A cloud server receives and unpacks original human body characteristic data packets transmitted from a terminal. If the cloud server determines that the transmitted data is correct, the cloud server prepares to start RAKE. According to requirements of an application (for example, an application for determining whether the user of the terminal has caught a cold or may probably catch a cold), the cloud server defines algorithms for correlation and recognition depth of characteristic data to perform RAKE configuration and starts the RAKE. The RAKE outputs updated human body characteristic data and packs the data, and then provides the packed data to a data reconstruction module. The data reconstruction module unpacks corresponding data packets (the characteristic recognition algorithm starts) according to requirements of the determination module (for example, a module for determining whether the user of the terminal has caught a cold), parses the collected sounds to obtain the sounds of the user during talks and the sounds of coughs, and then adds characteristic tags according to requirements. After finishing data validity recognition, the data reconstruction module confirms that the collected sounds during talks and the sounds of coughs are made by the user of the terminal, and thus the collected data about the sounds can be determined as valid characteristics then, validity tags can be added. according to requirements. The sounds made by other people than the user of the terminal may be put into an invalid characteristic library. The data reconstruction module outputs correlation data after operations of different characteristic data to analyze the changes in the. sounds made by the user during the successive calls and the sounds of coughs. Finally, characteristic tags, validity tags and correlation tags may be established based on the analysis results of characteristic recognition, the analysis results of validity recognition, and the analysis results of correlation recognition, and thus the characteristic data, the validity data and the correlation data can be repacked.

As can be seen from the above descriptions, the embodiments can realize the following technical effects (it should be noted that the technical effects can be realized by some exemplary embodiments). In the technical solutions provided by embodiments of the. present disclosure, voice, facial expressions and motion habit information of a human body in daily environments may be collected using devices such as a camera, a microphone, an acceleration sensor and a gyroscope equipped on a smart handheld terminal, and such information can be forwarded to a background cloud computing platform. The cloud computing platform processes the received information of the human body using a preset model match algorithm, and combines the processed information in a valid human body characteristic database at the cloud end. The database provides human body characteristic data support for establishing a virtual human which is equivalent of a real human.

It is apparent to one of ordinary skill in this art that the modules or steps as described above may be implemented using a general purpose computing device, the modules can be disposed on a single computing device, or can be distributed over a network consisting of a plurality of computing devices. Optionally, the modules may be implanted using program codes which are executable by a computing device so that these modules may be stored in a storage device to be executed by the computing device. Under some circumstances, the steps described or shown herein may be performed in a sequence different from that described herein, or the modules may be implanted as integrated circuit modules, or some of the modules or steps may be implemented using a single integrated circuit. The present disclosure is not limited to any specific combination of software and hardware.

Exemplary embodiments of the present disclosure have been described, and however the present disclosure is not limited to the embodiments described herein. One of ordinary skill in this art can made any changes and modifications without departing from the spirit and principle of the present disclosure, and all these modifications, equivalent substitutions, improvements fall within the scope as claimed.

The modules of the device for processing human body characteristic data may be implemented with one or more digital signal processors (DSP), application specific integrated circuits (AMC), processors, microprocessors, controllers, microcontrollers, field programmable gate arrays (FPGA), programmable logic devices, other electronic units, or any combination thereof. Some of the functions and processing described herein may also be implemented with software executed on a processor.

Certain aspects of the present disclosure may be implemented with a combination and hardware. For example, the method for processing human body characteristic data may be performed based on program codes executed on a processor.

For example, an embodiment of the present disclosure provides a device for processing human body characteristic data, including:

a processor; and

a memory for storing instructions executable by the processor;

wherein the processor is configured to:

receive a set of human body characteristic information transmitted by a terminal; and

according to requirements of an application to be run, extrac, from the set of human body characteristic information, human body characteristic data corresponding to the application to be run, and perform data reconstruction process on the extracted human body characteristic data.

### INDUSTRIAL APPLICABILITY

As can be seen from the above, in the method and device for processing human body characteristic data provided by embodiments of the present disclosure, voice, facial expressions and motion habit information of a human body in daily environments may be collected using devices such as a camera, a microphone, an acceleration sensor and a gyroscope equipped on a smart handheld terminal, and such information can be forwarded to a background cloud computing platform. The cloud computing platform processes the received information of the human body using a preset model match algorithm, and combines the processed information in a valid human body characteristic database at the cloud end. The database provides human body characteristic data support for establishing a virtual human which is equivalent of a real human.

1. A method for processing human body characteristic data, comprising steps of:
receiving a set of human body characteristic information transmitted by a terminal; and
according to requirements of an application to be run, extracting, from the set of human body characteristic information, human body characteristic data corresponding to the application to be run, and performing data reconstruction process on the extracted human body characteristic data.

2. The method according to claim 1, wherein the step of extracting, from the set of human body characteristic information, human body characteristic data according to requirements of an application to be run comprises:
according to the requirements of the application to be run, determining information about multiple categories which human body characteristic information to be used belongs to, wherein the human body characteristic information to be used comprises the human body characteristic data; and
extracting the human body characteristic data from the set of human body characteristic information according to the determined information about the multiple categories.

3. The method according to claim 2, wherein the step of performing data reconstruction process on the extracted human body characteristic data comprises:
classifying the human body characteristic data, and parsing the human body characteristic data of each category using a preset recognition algorithm;
analyzing validity of the parsed human body characteristic data according to the requirements of the application to be run; and
obtaining a correlation between the parsed human body characteristic data according to a preset correlation algorithm.

4. The method according to claim 3, wherein after the step of performing the data reconstruction process on the human body characteristic data, the method further comprises:
determining whether a preset event occurs and progress of the preset event using the human body characteristic data after the data reconstruction process.

5. The method according to claim 1, wherein the set of human body characteristic information comprises at least one of human body audio data, human body image data, and human body motion data.

6-10. (canceled)

11. A device for processing human body characteristic data, comprising:
a processor; and
a memory for storing instructions executable by the processor;
wherein the processor is configured to:
receive a set of human body characteristic information transmitted by a terminal; and
according to requirements of an application to be run, extract, from the set of human body characteristic information, human body characteristic data corresponding to the application to be run, and perform data reconstruction process on the extracted human body characteristic data.

12. The device according to claim 11, wherein the processor is configured to:
according to the requirements of the application to be run, determine information about multiple categories which human body characteristic information to be used belongs to, wherein the human body characteristic information to be used comprises the human body characteristic data; and
extract the human body characteristic data from the set of human body characteristic information according to the determined information about the multiple categories.

13. The device according to claim 12, wherein the processor is configured to:
classify the human body characteristic data, and parse the human body characteristic data of each category using a preset recognition algorithm;
analyze validity of the parsed human body characteristic data according to the requirements of the application to be run; and
obtain a correlation between the parsed human body characteristic data according to a preset correlation algorithm.

14. The device according to claim 13, wherein the processor is further configured to:
after perform the data reconstruction process on the human body characteristic data, determine whether a preset event occurs and progress of the preset event using the human body characteristic data after the data reconstruction process.

15. The device according to claim 11, wherein the set of human body characteristic information comprises at least one of human body audio data, human body image data, and human body motion data.

16. A non-transitory computer-readable storage medium having stored therein instructions that, when executed by a processor of a cloud computing platform, causes the cloud computing platform to perform a method for processing human body characteristic data, the method comprising:
receiving a set of human body characteristic information transmitted by a terminal; and
according to requirements of an application to be run, extracting, from the set of human body characteristic information, human body characteristic data corresponding to the application to be run, and performing data reconstruction process on the extracted human body characteristic data.
